(19) United States
(12) Patent Application Publication
(10) Pub. No.: US 2018/0014558 A1
(43) Pub. Date: Jan. 18, 2018

(54) NATURAL AND SUSTAINABLE SEAWEED FORMULA THAT REPLACES SYNTHETIC ADDITIVES IN FISH FEED

(71) Applicant: Ocean Harvest Technology (Canada) Inc., Vancouver (CA)

(72) Inventors: STEFAN KRAAN, County Galway (IE); PATRICK MARTIN, County Galway (IE); COLIN MAIR, Lincolnshire (GB)

(21) Appl. No.: 15/665,303

(22) Filed: Jul. 31, 2017

Related U.S. Application Data
(63) Continuation of application No. 13/384,445, filed on Mar. 29, 2012, now abandoned.
(60) Provisional application No. 61/271,148, filed on Jul. 17, 2009.

(51) Int. Cl. A23K 50/80; A23K 20/147; A23K 10/30; A23K 20/158; A23K 40/20

(52) U.S. Cl. CPC A23K 50/80; A23K 10/30; A23K 20/147; A23K 20/158; A23K 40/20

(57) ABSTRACT

A seaweed-based commercial salmon feed additive which replaces the synthetic chemical additives that are currently used in salmon fish feed is provided. Synthetic additives are replaced with a combination of seaweed species thereby providing a natural product that improves the nutritional value of the farmed fish, qualifies the fish for marketing as organic, reduces the environmental impact of fish farming practices and may replace the chemical use of lice treatment.

### CROSS-REFERENCE TO RELATED APPLICATIONS

The present application claims the benefits, under 35 U.S.C. §119(e), of U.S. Provisional Application Ser. No. 61/271,148 filed Jul. 17, 2009 entitled “Natural and Sustainable Seaweed Formula that Replaces All (Synthetic) Additives In Fish Feed” which is incorporated herein by reference.

### TECHNICAL FIELD

This invention relates to aquaculture. Certain embodiments provide feed pellets, methods of producing feed pellets, and natural additives for feed pellets.

### BACKGROUND OF THE INVENTION

Feed pellets used in aquaculture are typically composed of about 40% protein such as fish meal, about 30% fish oil, and about 30% other ingredients such as binders, fillers, vitamin and mineral mixes, colorants and antibiotic and other medical chemicals. The fillers and binders are used to bind the protein-rich ingredients together to improve stability in water, and to provide other desired properties to the feed pellets.

Feed pellets used in aquaculture typically include binders. Binders are substances which are used to improve the efficiency of the feed manufacturing process, to reduce feed wastage, and to produce a water-stable diet. For example, binders such as bentonites, lignosulphonates, hemicellulose and carboxymethylcellulose are used primarily within feed rations to improve the efficiency of the feed manufacturing process (i.e. during pelleting by reducing the frictional forces of the feed mixture through the pellet dies and thereby increasing the output and horse power efficiency of the feed mill) and for the production of a durable pellet (i.e. by increasing pellet hardness and reducing wastage in the form of ‘fines’ during the pelleting process and during handling and transportation). Ingredients commonly used as binders in feed pellets include wheat gluten (Glucans), sodium and calcium bentonites, lignosulfates, hemicellulose, carbomethylcellulose, alginates, and guar gum.

Colorants are used in feed pellets for salmon to meet the consumer preference for red coloration. For example, the petro-chemically derived synthetic keto-carotenoid pigments such as astaxanthin or canthaxanthin are often used as colorants. In order to meet the consumer preference for red coloration, salmonid flesh should contain at least 5-20 mg pigment per kg flesh. To achieve these levels at least 40-60 mg of canthaxanthin or 40-150 mg astaxanthin has to be added per kg of feed. However, public health concerns prompted the European Commission to reduce the permitted level of such colorants in salmon feed to 25 mg/kg (from the previous maximum level of 80 mg/kg). Keto-cartenoid pigments such as canthaxanthin and astaxanthin can also be expensive, accounting for about 10-15% of the overall cost of some conventional feed pellets.

Filler ingredients also often contain preservatives, such as, for example, ethoxyquin, which is often used as an anti-oxidant in fish feed. Without a suitable anti-oxidant the rate of oxidation in fish feed pellets can be such that the chemical heat is sufficient to cause fish meals to combust. However, a number of adverse effects has been reported in laboratory animals fed ethoxyquin (see National Toxicity Program, CAS No. 91-53-2, http://ntp.niehs.nih.gov/ntp/htdocs/Chem_Background/ExSumPdf/Ethoxyquin.s-ub.--508.pdf). In the European Union, the maximum permissible content of ethoxyquin in feed materials is 150 mg/kg, and the maximum allowable residue in food products for human use is 0.5 parts per million (ppm).

Conventional fish feed pellets can also lead to significant amounts of waste. Some of the waste is uneaten food, and some of the waste is faeces. Aside from the economic problems associated with such waste, uneaten food and faeces also have negative environmental impacts on aquaculture sites.

Another problem with some conventional feed materials is the susceptibility of individual feed ingredients and formulated feeds to oxidative damage (oxidative rancidity) and microbial attack on storage. For example, in the absence of natural antioxidant protection feed materials rich in polyunsaturated fatty acids (e.g. fish oils, fish meals, rice bran, and some expeller oil seed cakes) are highly prone to oxidative decomposition which in turn may cause a reduction in the nutritive value of the constituent lipids, protein and vitamins. Similarly, feed materials possessing an elevated moisture content (>15%) are prone to microbial attack and decomposition with a consequent loss in nutritional value for non-ruminant animals and deleterious mycotoxin production.

Another problem facing the aquaculture industry is that farmed fish can be susceptible to viral and other infections. For example, farmed salmon have been known to develop pancreatic disease. Accordingly, farmed fish are often vaccinated manually to provide resistance to disease. Such manual vaccinations can be costly and time consuming.

There are a number of patents and published patent applications relating to the use of various types of ingredients for feeding fish and other animals, including:

U.S. Pat. No. 4,125,392

U.S. Pat. No. 5,715,774

U.S. Pat. No. 5,722,346

U.S. Pat. No. 6,747,001

U.S. Pat. No. 6,764,691

U.S. Patent Application Publication No. 2008/0003326

PCT Publication No. WO 97/00021

PCT Publication No. WO 00/25602

PCT Publication No. WO 2004/043139

PCT Publication No. WO 2004/080196

PCT Publication No. WO 2006/115336

PCT Publication No. WO 2006/123939; and,

PCT Publication No. WO 2007/117511.

The inventor has determined a need for improved feed formulations for fish and other marine animals.

The invention therefore provides a seaweed-based commercial salmon feed ingredient which replaces the synthetic chemical additives that are currently used in salmon fish feed. Synthetic additives (including lice treatment) represent about 20% of the cost and 15% of the weight of the feed. The invention replaces the synthetic additives with a sustainable natural product that improves the nutritional value of the farmed fish, qualifies the fish for marketing as organic, reduces the environmental impact of fish farming practices and may replace the chemical use of lice treatment.

The invention is formulated on seaweeds that can be harvested around the world. The seaweeds are dried and milled, mixed, bagged and dispatched to customers. Since mixing is a low technology process based on readily available equipment, the supply of the constituent materials is facilitated.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Certain embodiments of the invention provide unique formulations of specific seaweeds and other marine ingredients for use in feed materials for fish. Some such formulations may be specifically configured for use in salmon farming, and may also be used for other farmed marine species, including, for example and without limitation, cod, shrimp and abalone.

Certain formulations described herein may be used as a pre-mix for addition to protein rich ingredients in the production of feed material, which may be formed into pellets or other shapes for consumption by marine animals. Formulations according to some embodiments of the invention may make up about 10-50% (by weight) of the final feed pellet or other feed product to be consumed, with the remainder made up by protein rich ingredients and oil. Some embodiments may, for example, provide a feed pellet made up of about 40-50% protein, 20-30% oil, and 15-40% of a formulation as described herein. In some embodiments, the formulation may account for about 25% of the total weight of the feed pellet. In other embodiments, such as those for more herbivorous animals such as, for example, abalone, the formulation may account for up to about 50% of the total weight of the feed pellet. Formulations according to example embodiments provide antibiotic, mineral and vitamin content to the feed material, as well as colorant to replace the chemical additives, such as astaxanthine in currently used commercial feeds.

The protein rich ingredients may comprise fish meal and/or shrimp meal in some embodiments. In other embodiments, the protein rich ingredients may comprise non-fish-based substitutes, such as, for example marine worms or other marine protein sources.

Formulations according to some example embodiments of the invention may be made by combining certain specific species of seaweed in various proportions as described below. The seaweeds are typically combined by drying them and then crushing the dried seaweeds into a powder which can be relatively easily blended. The dried seaweeds may also be combined with other ingredients, as discussed below.

Feed materials for salmon typically require about 40% protein content. Formulations according to some embodiments of the invention have protein contents in the range of 20-25% of the dry weight. Seaweeds used in some example formulations are rich in amino acids. Seaweed proteins degrade well in vitro by proteolytic enzymes such as pepsin, pancreatin and pronase.

Seaweeds used in some example formulations also contain lipids and fatty acids. Red and brown seaweeds used in some example formulations are rich in 20-carbon atom polyunsaturated fatty acids (C20-PUFAs), chiefly eicosapentaenoic acid (EPA, Ω 30-C20:5) and docosahexanoic acid (DHA), which are typically found in animals. Seaweeds are capable of metabolising various C20-PUFAs via oxidative pathways. In many red algae, the metabolised products of PUFAs, called oxylipins, resemble eicosanoid hormones in higher plants and humans which fulfill a range of physiologically important functions. Red and brown algae used in some example formulations also contain arachidonic acid (AA, Ω 6-C20:4), and 18-carbon polyunsaturated fatty acids (linolenic or linoleic). Brown seaweeds typically have a higher linolenic acid concentration than red seaweeds. Green algae used in some example formulations show useful levels of alpha linolenic acid (Ω 3-C18:3). Certain combinations of fatty acids have a strong immunological effect and can help fish to deter sea lice from attaching to the fish skin. Sea lice are a major concern in salmon farming and have a negative impact on growth and survival of fish.

Seaweeds used in some example formulations also contain relatively large amounts of polysaccharides. For example, some seaweeds used in example formulations contain cell wall structural polysaccharides such as alginates from brown seaweeds and agars and carrageenans from red seaweeds. Other polysaccharides contained in seaweeds used in some example formulations include fucoidans (from brown seaweeds), xylans (from certain red and green seaweeds), and ulvans in green seaweeds. Fucoidan is known to have a positive effect on skin and may help to combat sea lice. Seaweeds used in some example formulations also contain storage polysaccharides such as, for example, laminarin (B-1,3-glucan) in brown seaweeds and floridean starch (like glucan) in red seaweeds Seaweeds containing polysaccharides in the form of fucoidans are selected for use in some example formulations due to their desirable biological activities (e.g. anti-thrombotic, anti-coagulant, anti-cancer, anti-proliferative, anti-viral, and anti-complementary agent, anti-inflammatory).

Several sulphated macroalgal polysaccharides have cytotoxic properties. Fucoidans present in some example formulations are known to have anti-tumour, anti-cancer, anti-metastatic and fibrinolytic properties in mice. Seaweeds used in some example formulations contain laminaran. Enzymatic action on laminaran produces Translam, (1-3:1-6-β-D glucans), which has antitumour properties. Ulvan present in some example formulations has cytotoxicity or cytostaticity targeted to normal or cancerous colonic epithelial cells, which is of major importance in salmon farming also in respect of skin maintenance and deterring sea lice.

Seaweeds used in some example formulations also contain relatively large amounts of mineral elements, macro-elements and trace elements. The mineral fraction of some seaweeds accounts for up to 36% of dry matter. The following tables set out some typical mineral, vitamin, and other nutritional content of brown, red and green seaweeds used in some example formulations:

TABLE 1
Brown Seaweeds:

| Protein | 5-20% | |
|---|---|---|
| Fat | 2-4% | |
| Carbohydrates | 42-64% | |
| Mannitol | 4.2% | |
| Alginic acid | 26% | |
| Laminaran | 5-18% | |
| Fucoidan | 4-7% | |
| Vitamin A | 0.7-0.8 | ppm |
| Vitamin C | 500-1650 | ppm |
| B-Carotene | 35-80 | ppm |
| Vitamin B1 | 1-5 | ppm |
| Vitamin B2 | 5-10 | ppm |
| Vitamin B3 | 10-30 | ppm |
| Vitamin B6 | 0.1-0.5 | ppm |
| Vitamin B12 | 0.8-3 | ppb |
| Vitamin E | 260-450 | ppm |
| Vitamin H | 0.1-0.4 | ppm |
| Vitamin K3 | 10 | ppm |
| Calcium | 1-3% | |
| Iodine | 700-4500 | ppm |
| Iron | 101-176 | ppm |
| Magnesium | 0.5-0.9% | |
| Manganese | 10-15 | ppm |
| Sodium | 3-4% | |
| Zinc | 70-240 | ppm |

TABLE 2
Red Seaweeds:

| Protein | 12-37% | |
|---|---|---|
| Fat | 0.7-3% | |
| Carbohydrates | 46-76% | |
| Carrageenan | 40-45% | |
| Vitamin C | 130-1110 | ppm |
| B-Carotene | 266-384 | ppm |
| Vitamin B1 | 3-7 | ppm |
| Vitamin B2 | 2-29 | ppm |
| Vitamin B3 | 2-98 | ppm |
| Vitamin B6 | 9-112 | ppm |
| Vitamin B12 | 6.6 ppb-20 ppm | |
| Vitamin E | 1.71 | ppm |
| Calcium | 2000-8000 | ppm |
| Iodine | 150-550 | ppm |
| Iron | 56-350 | ppm |
| Magnesium | 0.2-0.5% | |
| Manganese | 10-155 | ppm |
| Sodium | 0.8-3% | |
| Zinc | 3 | ppm |
| Phosphorus | 0.8% | |
| Sulphur | 0.45% | |
| Boron | 16 | ppm |
| Flourine | 200 | ppm |
| Molybdenum | 39 | ppm |
| Chromium | 13 | ppm |
| Copper | 10 | ppm |
| Aluminium | <5 | ppb |
| Nickel | 30 | ppm |
| Cobalt | 6 | ppm |
| Selenium | 1 | ppm |

TABLE 3
Green Seaweeds:

| Protein | 10-25% | |
|---|---|---|
| Fat | 0.5-1.7% | |
| Carbohydrates | 42-48% | |
| Magnesium | 2.8% | |
| Vitamin A | 4286 | I.U. |
| Vitamin C | 40-200 | ppm |
| Vitamin B3 | 98 | ppm |
| Vitamin B12 | 6 | ppm |
| Calcium | 7300-9400 | ppm |
| Iodine | 70-240 | ppm |
| Iron | 152-1370 | ppm |
| Manganese | 12-347 | ppm |

| | |
|---|---|
| Sodium | 1.1-8.4% |

Formulations according to some example embodiments have relatively high antioxidant levels. High antioxidant content prolongs the shelf life of final feed products which include formulations according to certain embodiments of the invention, since essential fatty acids will be protected from going rancid. Seaweeds used in some example formulations are rich in polyphenols, which act as antioxidants. The highest content of polyphenols are typically found in brown seaweeds, where phlorotanin ranges from 5-15% of the dried weight. Seaweeds used in some example formulations are also rich in other antioxidants such as, for example, carotenoids, (especially fucoxanthin, B-carotene, and violaxanthin in some embodiments), and flavonoids.

Carotenoids in some example formulations are powerful antioxidants. Recent studies have shown the correlation between a diet rich in carotenoids and a diminishing risk of cardio-vascular disease, cancers (B-carotene, lycopene), as well as opthalmological diseases (lutein, zeaxanthin). Brown seaweeds are particularly rich in carotenoids especially in fucoxanthin, B-carotene, violaxanthin. The main carotenoids present in red algae are B-carotene and A-carotene and their dihydroxylated derivatives: zeaxanthin and lutein. The main carotenoids present in green algae are B-carotene, lutein, violaxanthin, antheraxanthin, zeaxanthin and neoxanthin.

Cartenoids in some example formulations also provide pigmentation. Such cartenoids avoid the need for chemically-produced keto-cartenoid pigments.

Formulations according to some example embodiments also contain bromophenols. The simple bromophenols, 2- and 4-bromophenol (2-BP, 4-BP), 2,4- and 2,6-dibromophenol (2,4-DBP, 2,6-DBP), and 2,4,6-tribromophenol (2,4,6-TBP), have been identified as key natural flavor components of seafood.

Formulations according to some example embodiments also contain feeding stimulants. Maximum benefit from feeding can only be achieved if the food provided is ingested. Ingestion efficiency depends on the feeding behaviour of the fish, shrimp or other animal to be fed. To maximize ingestion of feed materials, feed products presented should have the correct appearance (ie. size, shape and colour), texture (ie. hard, soft, moist, dry, rough or smooth), density (buoyancy) and attractiveness (ie. smell or taste) to elicit an optimal feeding response. The relative importance of these individual factors will depend on whether the fish, shrimp or other animal species in question is mainly a visual feeder or a chemosensory feeder. For example, although marine fish held in captivity generally rely on sight to locate their food, they also rely on chemoreceptors located in the mouth or externally on appendages such as lips, barbels and fins; the feed being carefully ‘sensed’ before ingestion. A similar situation also exists with marine shrimp and freshwater prawns. The use of dietary feeding stimulants for these cultivated species is therefore desirable to elicit an acceptable and rapid feeding response. In addition, by using feeding stimulants and improving feed palatability, the period of time the feed remains in the water can be reduced, thus minimizing nutrient leaching.

### EXAMPLES

Formulations according to some embodiments of the invention contain between about 40-75% (by weight) of Ulva Lactuca (“Ulva”). Ulva typically has the following nutritional content:

| Protein | 15-25% | |
|---|---|---|
| Fat | 0.6-1% | |
| Carbohydrates | 42-46% | |
| Vitamin A | 4286 | I.U. |
| Vitamin C | 100-200 | ppm |
| Vitamin B3 | 98 | ppm |
| Vitamin B12 | 6 | ppm |
| Calcium | 7300 | ppm |
| Iodine | 240 | ppm |
| Iron | 870-1370 | ppm |
| Magnesium | 2.8% | |
| Manganese | 347 | ppm |

| | |
|---|---|
| Sodium | 1.1% |
| Potassium | 0.7% |

The Vitamin C content of Ulva can be particularly beneficial in acting as a protective antioxidant, assisting the synthesis of connective tissue and neurotransmitters, regulation of iron metabolism and activating the intestinal absorption of iron, strengthening the immune defense system, controlling the formation of conjunctive tissue and the protidic matrix of bony tissue, and also in trapping free radicals and regenerates Vitamin E. Ulva has high levels of natural colorants and short chained polysaccharides which are useful for flesh coloring of the fish and improving gut health respectively.

The cell-wall polysaccharides of ulvales represent 38 to 54% of the dry algal matter. Two major kinds have been identified: water soluble ulvan and insoluble cellulose-like material. Ulvans are highly charged sulphated polyelectrolytes composed mainly of rhamnose, uronic acid and xylose as main monomer sugars and containing a common constituting disaccharide, the aldobiuronic acid, (1-4)-β-D-glucuronic acid-(1-4)-α-L-rhamnose3-sulfate-(1-2,12,16,22)-Iduronic acid is also a constituent sugar. Other potential applications of ulvan oligomers and polymers are related to their biological properties. Recent studies have demonstrated that ulvans and their oligosaccharides were able to modify the adhesion and proliferation of normal and tumoral human colonic cells as well as the expression of transforming growth factors (TGF-α) and surface glycosyl markers related to cellular differentiation. Earlier work demonstrated strain specific anti-influenza activities of ulvan from Ulva lactuca and the use of rhamnan, rhamnose and oligomers from desulphated Monostroma ulvans has been patented for the treatment of gastric ulcers.

Formulations according to some embodiments of the invention contain between about 0.5-7% (by weight) of Ascophyllum nodosum (“Asco”). Brown seaweeds such as Asco typically contain higher levels of vitamin E than green and red seaweeds. Asco typically has between about 200 and 600 mg of tocopherols per kg of dry matter. Asco also contains alpha, beta and gamma tocopherol, while green and red algaes typically only contain the alpha tocopherol. Gamma and alpha tocopherols increase the production of nitric oxide and nitric oxide synthase activity (cNOS) and also play an important role in the prevention of cardio-vascular disease. Asco also contains high levels of fucoidans (about 10-15% dry weight) and laminaran. Fucoidan is a polysaccharide with anti-viral and antibacterial properties.

Formulations according to some embodiments of the invention contain about 0.5% (by weight) of Lithothamnion corallioides, Lithothamnion glaciale and/or Phymatolithon calcareum, commonly referred to as “Maerl”. Maerl typically contains up to about 25-34% (dry weight) calcium content. Maerl also typically contains phycobiliproteins. Phycobiliproteins are made up of biline (tetrapyrolic open core) linked in a covalant way to a proteic chain. Phycobiliproteins present antioxidant properties. Maerl also typically contains about 3% Magnesium content. Maerl contains high levels of essential minerals and trace elements including Calcium, magnesium and phosphate which are all necessary for proper fish bone development.

Formulations according to some embodiments of the invention contain between about 5-10% (by weight) of Sargassum. This species contains high levels of essential antioxidants improving shelf life of fish, and also adds high levels of alginates and fucoidan, which have antibacterial and antiviral properties, and being long chained polysaccharides improve gut health, reduce bad bacteria (entero bacteria and E. coli) and increases good bacteria thereby permitting better nutrient absorption and hence growth.

Formulations according to some embodiments of the invention contain between about 2-8% (by weight) of Gracilaria. This species contains high levels of bromophenolic compounds improving taste of the farmed marine animal and high levels of protein and hence of essential amino acids.

Formulations according to some embodiments of the invention contain between about 2-10% (by weight) of Laminaria. This species contains high levels of Laminarin and alginates for gut health and antibacterial and antiviral as well as immunostimulant properties.

Formulations according to some embodiments of the invention contain between about 1-3% (by weight) of Palmaria palmata. This species contains kainic acid and is a helmintic agent (anti intestinal worm).

Formulations according to some embodiments of the invention contain about 0.1% (by weight) of Plocamium cartilagineum. This species has high levels of mono-terpenoids.

Formulations according to some embodiments of the invention contain about 0.1% (by weight) of Osmundia pinnatifida. This species has high levels of di-terpenoids.

Formulations according to some embodiments of the invention contain between about 0.05-1.0% (by weight) of a combination of equal parts Polysiphonia, Falkenbergia, and Delleseria. These species have high levels of bromophenols which improve the taste of farmed fish or marine animals such as shrimp. Polysiphonia is a marine red algae of the family Rhodomelaceae, which are a rich source of bromophenols. This family contains a variety of bromophenols with a range of biological activities, including feeding deterrent, R-glucosidase inhibitory, and growth stimulatory effects. Polysiphonia lanosa contains lanosol, 2,3-dibromo-4,5-dihydroxybenzyl alcohol. Lanosol has been known as a highly toxic substance for bacteria and algae. The red alga Asparagopsis taxiformis and tetrasporophyte Falkenbergia rufulanosa contains at least 52 organobromine compounds. Falkenbergia contains the halogenated natural product previously named mixed-halogenated compound 1 (MHC-1) was isolated from the red seaweed Plocamium cartilagineum. A total of 1.9 mg of pure MHC-1 was obtained from 1 g air-dried seaweed. The structure of MHC-1 was established to be (1R,2S,4R,5R,10E)-2-bromo-1-bromomethyl-1,4-dichloro-5-(20-chloroethenyl)-5-methylcyclohexane.

Formulations according to some embodiments of the invention contain between about 0.1-2.0% (by weight) of Polychaete Meal. The Polychaeta or polychaetes are a class of annelid worms, generally marine. More than 10,000 species are described in this class. Common representatives include the lugworm (Arenicola marina) and the sandworm or clam worm Nereis. Polychaetes can be used as a very good feed attractant mainly due to the amino acid composition. Polychaetes also have high protein and oil content, and as such may be used as a replacement for fish meal and fish oil in some embodiments.

Formulations according to some embodiments of the invention contain between about 0.5-1.0% (by weight) of flavonoids. Certain embodiments contain citrus flavonoid extracted from specially bred citrus fruit such as lemons and oranges which have been selectively bred for high levels of flavonoids. Commercial products containing concentrated flavonoids are typically made by drying the rind and seeds of citrus fruits. Citrus flavonoids have a bitter flavor, being part of the natural defense mechanism of the citrus fruits. Flavonoids suppress mast cell activity and associated tissue inflammation and may have a positive effect on skin and skin damage caused by sea lice. Flavonoids can also act as a natural biocide and provide flavor enhancement.

The following table sets out the content of an example formulation which has been specifically developed as a natural additive for salmon feed, but may also be useful as an additive in feeds for other fish and marine animals:

| Ingredient | % (by weight) |
|---|---|
| Ulva | 65 |
| Asco | 5 |
| Sargassum | 10 |
| Gracilaria | 6 |
| Laminaria | 10 |
| Palmaria | 2 |
| Maerl | 0.5 |
| Polysiphonia, Falkenbergia, Delleseria | 0.1 |
| Osmundia pinnatifida | 0.1 |
| Plocamium cartilagineum | 0.1 |
| Polychaete Meal | 0.5 |
| Flavonoids | <.5 |

Preliminary inspection of salmon that were fed a diet including the above formulation added to fish meal and fish oil has shown favorable results for overall fish health, size and weight of fish, and palatability of feed material in comparison with fish fed a traditional diet. Also, it was observed that fish on a diet including the above formulation had lower fishlike infections in comparison with fish fed a standard diet, and that after 5 weeks on a diet including the above formulation fish showed improved pigmentation uptake resulting in pinker flesh, in comparison with fish fed a standard diet. Further, salmon fed a diet including the above formulation for 5 weeks appeared to recover more readily from the effects of anaesthetic, in comparison with fish fed a standard diet.

### Manufacturing Process

Formulations according to certain embodiments may be combined with protein rich ingredients to make feed pellets in an extrusion-type pelletizing process. The temperature of the ingredients in the process may stay below 40° C. in some embodiments in order to preserve nutritional content. Keeping the temperature relatively low also results in energy and cost savings, as discussed below.

Feed pellets including formulations according to certain embodiments may be made using a standard extrusion system. However, feed pellets including formulations according to certain embodiments may advantageously be made on an adapted extrusion system, wherein screw flightings are changed to convey positively forward, reducing shear forces and temperature in the extruder. Forming extruders are again available as standard equipment and the change of screw flightings can be done on any cooking extruder.

In a typical aquatic feed production process it is necessary to subject the ingredients to a heat process using a combination of thermal (steam) and mechanical energy inputs. In an extruded pellet it is typical to add 7% steam in the pre-conditioner and 2% steam in the extruder, equivalent to an energy input of 57 kWh/tonne product. In a pelleting system pre-conditioners add up to 5% steam and post-conditioners add a further 2% steam, equivalent to 44 kWh/tonne. The reasons for heating the ingredients are to pasteurize them and to cook the starch, which can only act as an adhesive and/or structural polymer after it has been cooked (after it has undergone transformation from a crystalline solid to a glassy fluid). Also, uncooked starch causes gastro-intestinal irritation in salmon such as, for example, eruption of intestinal ulceration. To pasteurize the ingredients it is necessary to raise them to a temperature of 80° C. If an ambient temperature of 20° C. is assumed this requires an energy input of 84 kJ/kg or 23 kWh/tonne. The mechanical energy transferred to the ingredients in a typical extrusion system varies from 19 to 40 kWh/tonne.

In contrast, in the manufacture of feed pellets containing formulations according to certain example embodiments of the invention, it is not necessary to ‘cook’ the mixed ingredients. The adhesive properties of the formulations only require that the product be hydrated to similar levels as in existing extrusion and pelleting systems. The low starch content avoids the gastro-intestinal problems associated with uncooked starches. There is no need for the very high mechanical energy inputs that are used in existing extrusion systems, the only energy required being enough energy to compress the pellets before the die. This takes energy inputs down as low as 23 kWh/tonne thermal and 19 kWh/tonne mechanical in some embodiments, a potential reduction of 55 kWh per tonne.

The relatively low temperature used in the manufacture of feed pellets containing formulations according to certain example embodiments of the invention avoids thermal/oxidative degradation of certain nutrients such as Vitamin C, Thiamine, Riboflavin and Polyunsaturated Lipids. Materials such as carotenoid pigments are also decolorised at high temperatures. In some embodiments, the ingredients are maintained below 40° C. In some embodiments, the ingredients may be heated up to the minimum levels required for pasteurization. Thermal damage may thus be minimized, improving delivery of these nutrients and pigments. In processes where the ingredients are ‘cooked’, as required for starch-based formulations, it is typically necessary to add a surplus of these materials which increases cost and increases the carbon footprint of the feed products.

Existing aquatic feed process apparatus can be adapted to manufacture feed products containing formulations according to certain example embodiments of the invention. Alternatively, feed manufacturing apparatus may be specifically designed for making feed products containing formulations according to certain example embodiments of the invention which do not need the same complexity of equipment. For example, pre-conditioners are typically not needed for production of feed products containing formulations according to certain example embodiments of the invention. For extruded feed products containing formulations according to certain example embodiments of the invention it is possible to use a ‘new generation’ contra-rotating twin screw extruder to mix water with the dry ingredients and make the feed pellets at minimum energy. This can substantially reduce capital costs, and represent an extra saving in energy costs of more than 5 kWh/tonne, as pre-conditioners have large electric motors. Pellet mill systems for production of feed products containing formulations according to certain example embodiments of the invention also do not need extensive pre-conditioning systems and this, combined with the use of modern dual drive pellet mills, results in further energy savings on top of capital savings.

Some embodiments may use a specially adapted extrusion system as described below:
There is no steam injection at any point in the process. In a typical pre-conditioner it is normal to inject 7% steam. This 70 kg/tonne requires 157,920 kilojoules per tonne or an energy input of 44 kWh/tonne. In a typical extruder it is normal to inject 2% steam or 20 kg/tonne, requiring a further 45,120 kilojoules per tonne or 12.5 kWh/tonne.
Shearlocks, backflow elements and cut flights may be removed from a typical extruder, turning the machine into a positively conveying forming machine. In a typical extruder, the specific mechanical energy (electrical power to the extruder) required is 25-30 kWh per tonne. In adapted extruders according to some embodiments the mechanical energy input is reduced to about 10 kWh per tonne.
The extrusion system may be adapted to handle non-fluid extrudate. Counterflow twin screw extrusion is a new technology in the feed industry which may be employed in some embodiments, further reducing the mechanical energy input to about 5 kWh per tonne.
The system may be designed to include a gravity drop design from the extruder to the dryer to prevent product breakage, providing further energy savings of about 5 kWh per tonne.

In some embodiments, an existing extrusion system may be adapted such that formulations as described herein can be added to other ingredients after they leave a cooking extruder and as they enter into a forming extruder so that fishmeal and even starch can be cooked before addition of the formulation. This allows low temperature processing of the formulation to preserve nutrient and colorant properties. The forming extruder may be a twin screw extrudrer with a mixing zone followed by a forming zone. This makes any existing plant adaptable with a relatively easy retrograde addition. The adapted extrusion system can then still make ordinary products with increased efficiency, but the second, forming, extruder allows products including formulations as described herein to be made. The forming extruder may have its own ingredients intake system allowing formulations as described herein to bypass the intensive cooking process.

The use of formulations according to certain example embodiments of the invention also increases the stability of feed pellets when immersed in water. This results in more of the feed material being eaten and less being dispersed in the water, which reduces pollution of the water by uneaten feed. The low starch content of certain example formulations may also be advantageous in some environment, since starch is not a material typically found in the sea and can cause a BOD and Eco-Toxicity problem. BOD issues are lower with feed pellets including formulations according to certain embodiments because of the low starch content of the formulation.

Also, elimination of starch from salmon feed frees up cereals for consumption by humans or other animals. For example, eliminating 20% cereals from salmon feed products would release 200,000 tonnes of cereal into the food chain for each million tonnes of salmon feed made.

The use of formulations according to certain example embodiments of the invention also reduces the total carbon footprint of feed pellet production, since there are no additional processing and shipping costs linked to micronutrients which are added to conventional feed pellets. Such micronutrients are typically produced in China and shipped to other locations around the world where the pellets are made.

The structure of pellets including formulations according to certain embodiments gives improved diffusibility of water in the dryer (there are no glassy plastic starch walls in the pellet) which allows the product to be dried at lower internal air temperatures, giving improved dryer efficiency. The structure of pellets including formulations according to certain embodiments also makes oil diffuse into the pellet easily and the oil is more firmly bound, reducing leaching and thus improving nutritional delivery and reducing environmental problems. The final feed pellets are strong, water stable and sink slowly. This ensures maximum feed uptake and minimum environmental degradation.

### EXAMPLE

Applicant produced a salmon feed with seaweed blend additive based on the formulation disclosed herein and undertook a comparative feeding trial using the EWOS Harmony diet (an existing organic diet, referred to herein as the Harmony diet) as reference diet. Trials were run with fish weighing 250-300 g and with fish weighing 5-5.5 kg. The objective was to compare the growth, mortality, taste, colorant uptake and flesh quality of farmed Atlantic salmon (Salmo salar L) when fed either a high organic EWOS diet (Harmony) or the inventive seaweed-based diet disclosed herein. The effect on sea lice burden was also compared using both diets.

The trial was broken into two phases using two formulations of the presently disclosed seaweed formulations:

PHASE 1
Diet
A = Seaweed inclusion: B = Control: Harmony 250 formulation
Composition

| Diet A | % | Diet B | % |
|---|---|---|---|
| Organic Fish meal | 59.2 | Organic Fish meal | 55.2 |
| Organic Fish oil | 14.8 | Organic Fish oil | 14.0 |
| Seaweed meal 1 | 25.5 | Wheat | 15.0 |
| Seaweed meal 2 | 0.5 | Minerals | 0.5 |
| | 100.0 | FW and SW vits | 0.3 |
| | | Sunflower cake | 5.0 |
| | | Shrimpmeal | 10.0 |
| | | | 100.0 |

PHASE 2
Diet A

| FORMULATION 1 | | Protein | Fat | Protein | Fat |
|---|---|---|---|---|---|
| Organic wheat | 10.00 | 10 | 0 | 1.0 | 0.0 |
| Organic fishmeal | 54.47 | 69 | 11.4 | 37.6 | 6.2 |
| Trimmings oil | 20.53 | | 100 | 0.0 | 20.5 |
| Seaweed Blend | 15.00 | 24 | 2 | 3.6 | 0.3 |
| VOL % | 100.00 | | | 42.2 | 27.0 |

| | | |
|---|---|---|
| | | Target |
| MOISTURE % | 6.71 | |
| CP % | 42.2 | 42.0 |
| FAT % | 27.0 | 28.0 |

### Diet B—Harmony 1000

The trials lasted for 13 months using mixed sex S1 09 Atlantic salmon smolts, and at an approximate start weight of about 250 grams. The two diets each had three replicates (6 cages total) of 600 fish, totaling 3600 fish. Each 125 square meter cage was equipped with sterner feeders controlled by an Aquasmart AQ300 adaptive feed control system. Fish were fed to satiation and with the light regime following natural photoperiods. Water temperature was ambient. Cages were inspected daily, with temperature and salinity recorded at 6 and 4 m respectively. Mortality was monitored daily, and records kept included date, cage ID, number, and weight of mortality prior to submission for post-mortem examination.

The fish were assessed against standard farming KPIs and evaluated for flesh quality parameters for each of the two diets; one standard and one test. Growth parameters and FCR were observed during the trial. Quality aspects included condition factor, yield, pigmentation, and fat analysis.

Fish were allocated to groups at random before being transferred to trial pens, again at random and following the use of a randomized block design. They were allowed to acclimatize for a minimum of two weeks prior to trial start date. A total of 615 fish were transferred to each cage to allow for post-transfer mortality. 150 fish were individually weighed and length taken from each cage at the beginning of the trial. At trial commencement, 30 extra fish (5 fish per cage) from the trial population were used for baseline data. These fish were weighed, length and a Scottish Quality Cut (SQC) taken. The SQC was labeled, SalmoFan scores taken, and lipid content and astaxanthin levels were tested.

The trial population was sampled as follows:
Fish number at start: count
Fish weight at start: average weight of each unit (200 per cage)
Quality sampling at start: SQC, yield, CF (5 fish per cage
Fish weight at mid-point: average weight of each unit (200 per cage).
Quality sampling at mid-point: SQC (fat and pigment), Salmofan, yield, CF (24 fish per cage)
Fish weight at end-point average weight of each unit (200 per cage)
Quality sampling end-point: SQC (fat and pigment), Salmofan, yield, CF (36 fish per cage)
Fish number at end: count
Daily feed amount given
Temperature and oxygen at two depths (5 and 10 meter)
Flow logging at 5 meter
Mortality (date, cage, number, weight, post-mortem analysis).

Individual sample weights for growth analysis were conducted at the start of the trial, at 4 months, 6 months 9 months and at termination. 200 fish were individually weighed and length taken. Similarly, at 0, 3, 6, 9 and 12 months, a random selection of 5, 36, and 36 fish per cage respectively were removed for quality sampling. These fish were lengthed, weighed, examined for abnormalities, gutted and re-weighed, before a Salmofan score was taken at three standard points on one fillet and the SQC taken for lipid and pigmentation analysis. The 36 fish of each cage were pooled into 3 pools of 12 fish, categorised by weight; small, medium, and large.

Prior to collection of trial start data, all fish were bath treated for sea lice (Lepeophtheirius salmonis and Caligus elongatus) using the deltamethrin-based Alpha Max (Pharmaq). Further sea lice treatments were conducted periodically. Prior to sea lice treatments 25 fish per pen were assessed for parasite burden. Routine sea lice assessments were also performed between sea lice treatments, but at 10 fish per pen. A microbiological assessment was taken on the fish intestines and a histological examination of salmon intestines.

In order to compare the taste of two salmon fed on different diets, a focus group, was established of members of the public to taste the fish in a double blind taste test. Fillets were prepared and cooked in the same way preferably with as little seasoning or sauce as possible. Reports were made on detailed categories (below), plus any additional information (tastes: bitter, sweet, strong; texture: soft, firm; smell: earthy, rich, light; color: pale, translucent etc). The rating scale was: 1=Excellent 2=Good 3=Indifferent 4=Poor 5=Terrible.

### Results

The following results were obtained:
a) In Phase I, the Harmony feed (“Diet B”) had higher oil, protein and lower moisture content indicating that both feeds were not isonitrogenous and isocalorific with Diet B delivering considerable more energy per gram dry weight of feed. During the first 3 months growth was at par although weight gain was lower in the seaweed-based diet (“Diet A”) caused due to higher oil and protein content and a 8% lower moisture level in Diet B compared to Diet A. Differences are explained due to that the two diets are not isocalorific and isonitrogenous. In Phase 2 both diets were manufactured to be isocalorific and isonitrogenous. Over the second period of the trial, the Diet A showed a better feed conversion ratio (2.2% better than Diet B), gutted weight of fish (1.4% better than Diet B), EWOS growth Index (8.9% better than Diet B) and mortality rates (3 times lower than Diet B).
b) The SalmoFan scores for fish raised on both diets was identical. Diet A had higher levels of Omega 3 PUFA's. Total lipids was 2.17% higher in Diet B delivering more energy. Oil levels in fish flesh did not differ significantly between diets. Astaxanthin levels in Diet B were 5 times the levels present in Diet A which contained higher levels of natural pigments and astaxanthin-like Esters notably lutein and other unidentified Esters. The SalmoFan values showed identical uptake values of pigmentation. The analysis of fish flesh of small medium and large fish of all pens of both diets showed no significant differences for pigment uptake for carotenoids and astaxanthi. Since Diet A used no chemical astaxanthin or Phaffia yeast, that indicates that the supplied natural pigments (carotenoids and other esters) were converted into astaxanthin in the fish providing similar levels as the Phaffia yeast fed Diet B fish.
c) The double blind taste panel results showed a general preference for the Diet A fed fish raw and cooked (see scores below). This is an effect of the high levels of bromophenolic compounds in selected macroalgae used in Diet A having a marked influence on taste. It was observed that the Diet A fed fish were more firm in flesh quality and kept the pigmentation better after cooking. This may be caused due to a different oil composition, different protein profile and different pigment make-up in the Diet A fed fish compared to Diet B fed fish. The effect of holding color in Diet A fed fish after cooking is probably caused due to the fact that fish synthesise their own astaxanthin and incorporate it in muscle flesh using a variety of natural pigments and esters present in Diet A compared to the astaxanthin from Phaffia yeast added to the Diet B feed.

Taste Test
Where 1 is excellent and 5 is poor
Number 1 (n = 14)

| Mean (overall) | A | B |
|---|---|---|
| Appearance | 2.08 | 2.25 |
| Texture | 2.25 | 2.17 |
| Colour | 2.09 | 2.36 |
| Smell | 2.00 | 1.73 |
| Taste | 3.00 | 3.00 |
| Appearance | 2.17 | 2.58 |
| Texture | 1.92 | 2.54 |
| Colour | 2.54 | 2.62 |
| Smell | 2.33 | 2.50 |
| Taste | 2.08 | 2.46 |
| General rating | 2.08 | 2.75 |
| overall | | |

Number 2 (n = 10)
Taste Test A = 2.39
Taste Test B = 2.70

d) No significant differences were found between the intestines and microbiological analysis and no pathogens were detected, however the Diet B fed fish developed heavier intestines which can be an effect of plant protein utilization in the diet and will lower the average gutted fish weight for fish fed on Diet B.
e) A histological examination of intestines of fish fed the Diet A or Diet B did not reveal any differences or negative effects.
f) Diet A had a significant effect on sea lice specifically pre-treatment with an anti-lice treatment (Alpha-Max) but also 6 days after treatment. Especially numbers of egg bearing female lice and adult females and males were lower on the Diet A fed fish compared to the Diet B fed fish. The results indicated that the bioactive molecules in Diet A had a negative effect on the recruitment and re-population of lice on the fish.

### GENERAL CONCLUSION

Fish fed the seaweed-based diet showed improved weight gain, better feed conversion ratio's better growth index, a higher gutted weight and less mortality, better natural pigmentation and reduced lice recruitment and re-population. Using the disclosed seaweed-based diet could therefore save a fish farmer on feed use (based on feed conversion ratio), and produce healthier and better fish with less money spent on feed.

While a number of exemplary aspects and embodiments have been discussed above, those of skill in the art will recognize certain modifications, permutations, additions and sub-combinations thereof.

1. An additive for use in feed for fish and other marine animals containing between about 40-75% (by weight) of Ulva Lactuca (“Ulva”) and between about 0.5-7.0% (by weight) of Ascophyllum nodosum (“Asco”).

2. The additive of claim 1 containing about 0.5% (by weight) of Lithothamnion corallioides, Lithothamnion glaciale and/or Phymatolithon calcareum (“Maerl”).

3. The additive of claim 1 or claim 2 containing between about 5-10% (by weight) of Sargassum.

4-28. (canceled)
